(19) United States
(12) Patent Application Publication
(10) Pub. No.: US 2025/0171359 A1
(43) Pub. Date: May 29, 2025

(54) POROUS SOLID DRAINAGE MATERIAL WITH PARTICULATE PHASE BOUND BY HYBRID OPC-GEOPOLYMER PHASE

(71) Applicant: Allied Success Technology Development Limited, Hong Kong (HK)

(72) Inventors: Chung Kong CHAU, Hong Kong (HK); Nok Hang Enoch WONG, Hong Kong (HK); Chi Fai CHENG, Hong Kong (HK); Allan Sau Kit CHAN, Hong Kong (HK); Ian Pui Hong CHAN, Hong Kong (HK); Man Lung SHAM, Hong Kong (HK); Lai Ming Gordon LEUNG, Hong Kong (HK)

(21) Appl. No.: 18/962,698

(22) Filed: Nov. 27, 2024

Related U.S. Application Data
(60) Provisional application No. 63/602,683, filed on Nov. 27, 2023.

(51) Int. Cl. C04B 28/08; C04B 18/14; C04B 18/167; C04B 18/22; C04B 103/32; C04B 103/54; C04B 111/00; E01C 11/22

(52) U.S. Cl. CPC C04B 28/08; C04B 18/146; C04B 18/167; C04B 18/22; E01C 11/226; C04B 2103/32; C04B 2103/54; C04B 2111/00284; C04B 2111/0075

(57) ABSTRACT

An environmentally-friendly and sustainable porous solid surface-water drainage material with high recycled waste content and excellent water infiltration rate is provided. A first phase of recycled particulate materials is bound by a second hybrid geopolymer/OPC phase to create a material having a porosity of 10-25 percent, a water filtration rate of at least 18,000 mm/hr, a 28-day compressive strength of at least 10 MPa, and a density of less than 1,850 kg/m³. The porous solid surface-water drainage material may be used for high drainage regions such as solid surface storm drains and other infrastructures that permit passage of water while preventing access to standing water by mosquitoes and other insects, thereby preventing insect-borne disease transmission. The material can be dyed and shaped for a variety of infrastructure applications, resulting in improving road and pavement safety.

### CROSS-REFERENCE TO RELEVANT APPLICATION

The present application claims priority from a U.S. provisional patent application Ser. No. 63/602,683 filed Nov. 27, 2023, and the disclosure of which are incorporated by reference in their entirety.

### FIELD OF THE INVENTION

The present invention relates to the porous solid surface-water drainage materials with high porosity and high water throughput. The drainage material possesses an excellent water infiltration rate and strong mechanical properties.

### BACKGROUND OF THE INVENTION

Surface water drainage systems, also known as storm drain systems, are among the most important public infrastructure in any modern city, in order to effectively remove any ground water or excess rain water and hence prevent flooding. Flooding due to typhoons and tropical depressions is particular concerning in tropical or sub-tropical cities such as Hong Kong, Shenzhen, Taipei, and Manila. During typhoon and monsoon seasons monthly rain often exceed 400 mm; during intense rainfall events, several hundred millimeters of rain may fall within a 24-48 hour period.

Most urban storm drains use grated inlets covers, i.e., the storm drains entrances are placed on the surface of the road covered with metal gratings. However, the design of metal gratings poses several problems. Firstly, the openings between grated bars, while preventing people, vehicles and large debris from falling into the storm drains, may still be wide enough for sediment and small objects to fall through, the accumulation of which may clog the drainage channels, which in turn leads to flooding.

In addition, when the drainage flow is impeded by sediment, leaves, and other debris, stagnant water pools form, becoming a breeding ground for mosquitoes and other insects. The openings of the metal gratings allow adult mosquitoes to escape from the storm drains, posing problems not only of mosquito infestation, but spreading of vector-borne diseases transmitted by mosquitoes, including dengue fever, Japanese encephalitis and malaria, posing a threat to public health. Rodents such as rats and mice also use the pooled water as a water source and the storm gratings as access ports to storm drain tunnels. These rodents are also disease vectors that impact public health.

Storm gratings can pose risks to pedestrians, cyclists, and small-wheeled vehicles. Objects, shoes, or bike tires can get caught in the gaps, causing accidents. The bars themselves, particularly when wet, create a slippery surface for pedestrians. Additionally, grating bars are easily corroded or damaged during their service lives, leading to costly repairs or replacements. Metal gratings are also unsightly road or pavement features.

In response to the extreme weather conditions, the concept of “spongy cities” has been emerging. Spongy cities which incorporate porous pavements and construction materials which are able to efficiently absorb and manage excess rainwater, preventing flooding. By absorbing or diverting rainwater into networks of drainage tunnels, urban resilience is enhanced, preventing flooding during increasingly frequent adverse weather events and extended typhoon seasons.

However, existing porous materials generally lack sufficient mechanical strength, for use in structural applications. Therefore, existing porous materials cannot adequately support regular pedestrian or vehicle use, and are not ready for large-scale implementation to create spongy cities.

Therefore, there is a need in the art for improved porous materials that can absorb and divert rainwater during adverse weather events with high rainfall rates in short periods of time. Such materials need to be both strong and porous, in addition to being low cost and able to integrate into existing infrastructure. The present invention addresses this need.

### SUMMARY OF THE INVENTION

In response to the above-mentioned challenges and demands, as described below, the present invention provides a porous solid surface-water drainage material not only equipped with high water infiltration rate and high mechanical strength, but also with a high content of recycled materials, which addresses both the need for an improved drainage materials and the high demand for waste recycling.

In other words, the porous drainage material of the present invention is formulated to be capable to efficiently drain the surface rainwater off to the underground storm drain system during downpours during extreme weather events occurring during monsoons, typhoons, and tropical depressions, including rainfall rates of up to several hundred millimeters per hour. In a first aspect, the present invention provides porous solid surface-water drainage material having a first phase of a recycled particulate mixture bound with a second phase of cementitious binder, the first phase can be recycled waste concrete aggregates, recycled waste glass, recycled waste plastic, recycled tire rubber crumbs, and mixtures. The second phase of cementitious binder is a novel hybrid OPC-geopolymer concrete binder phase. The hybrid binder of Ordinary Portland Cement (OPC) and a geopolymer-forming material is selected from granulated ground blast furnace slag (GGBS), fly ash, metakaolin, or mixtures thereof. The OPC portion creates calcium silicate hydrate bonds for binding to the first phase recycled particulate mixture to strengthen the porous solid surface-water drainage material. The geopolymer forms a secondary rapid-hardening portion of the second phase of cementitious binder, reacting in part with calcium hydroxide produced from OPC hydration to create calcium-alumino-silicate hydrate. The ratio of OPC to geopolymer in the second phase of cementitious binder is 3 to 1 or higher. The first phase ranges from approximately 70 to approximately 80 weight percent of the material and the second phase ranges from approximately 15 to approximately 25 weight percent of the material. Note that these numbers relate to the phase 2 binder as dry mix materials that have been reacted with water, hydrating the OPC and geopolymer binder starting materials. Typically, for a dry mix, 5 to 10 weight percent water will be used for mixing and hydration. The solid porous solid surface-water drainage material has a porosity of 10-25 percent, a water filtration rate of at least 18,000 mm/hr, a 28-day compressive strength of at least 10 MPa, and a density of less than 1,850 kg/m³.

In a further aspect, the porous solid surface-water drainage material includes a metal supporting frame surrounding a block of the porous solid surface-water drainage material.

A solids content of debris-containing water passing through the porous solid surface-water drainage material is less than 1% by weight of a total debris content in the debris-containing water.

The porous solid surface-water drainage material has a skid resistance value (SRV) of at least 60.

The second phase of the porous drainage material may further include silica fume in an amount of approximately 1 to 5 percent of the binder phase.

The porous solid surface-water drainage material can further include superplasticizer selected from polycarboxylate amine (PCA), polycarboxylate ether (PCE), modified lignosulfonates, vinyl copolymers, acrylic-based superplasticizers, or a combination thereof.

The porous solid surface-water drainage material can further include concrete pigments with an amount of less than 10% by weight relative to the second phase of the material.

A method of producing the porous solid surface-water drainage material is also provided in which a dry mix of the OPC, geopolymer materials and recycled particulates in a concrete mixer to obtain a first mixture. Water and the superplasticizer is added to the first solid mixture and mixed to obtain a second mixture. The second mixture is formed into a holding frame while ensuring even distribution of the second mixture within the holding frame followed by compaction; and flattening the surface to obtain the porous surface-water drainage material within to create modular unit with variable shapes, such as drain covers as shown in FIGS. 1A-1B.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

Embodiments of the invention are described in more details hereinafter with reference to the drawings, in which:

FIGS. 1A-1B show finished porous drainage materials with natural and pigment-added colors of the present invention;

FIG. 2 shows the size of the recycled aggregate used in the Examples

FIG. 3 shows the recycled rubber tire crumb used in the formulation of the Examples.

FIG. 4 shows the raw materials, including recycled rubber tire crumb and plastic, used for the production of porous drainage material.

FIG. 5 depicts an example of a frame for holding the porous drainage material.

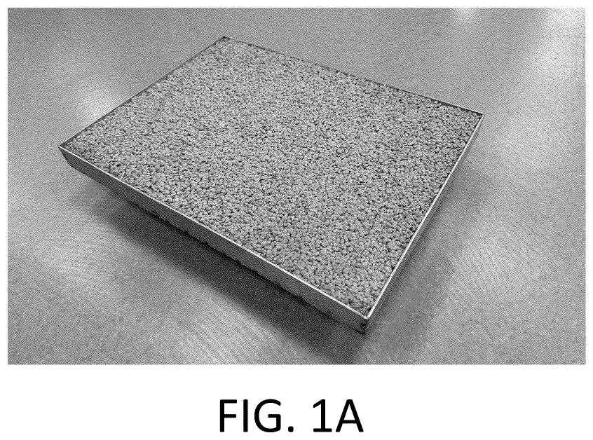

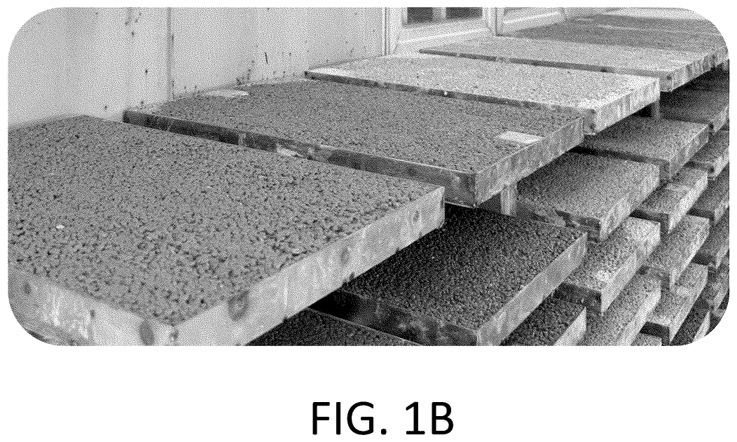

### DETAILED DESCRIPTION

The invention relates to a porous solid material designed for surface-water drainage, providing a sustainable, high-performance solution for urban and infrastructure applications. This material integrates recycled waste particulates into a hybrid cementitious binder, yielding a durable, porous structure with exceptional drainage and load-bearing properties. The porous drainage material provides safety and accessibility since the solid surface eliminates gaps found in traditional grates, reducing risks for pedestrians, cyclists, and vehicles. The use of recycled particulates reduces resource consumption and diverts waste from landfills. The absence of open gaps minimizes mosquito breeding by restricting access to standing water below. The disclosed porous solid material is well-suited for urban drainage systems, sidewalks, parking lots, and other infrastructure requiring sustainable and high-performance drainage solutions.

### A. Overview of the Drainage Material

The porous drainage material is composed of two primary phases:
1. Recycled Particulate Mixture: The first phase consists of recycled materials selected from waste concrete aggregates, waste glass, waste plastic, tire rubber crumbs, or mixtures thereof. This phase accounts for approximately 70-80% of the total weight of the material. The recycled particulates provide structural porosity and environmental sustainability by reusing materials that would otherwise contribute to waste streams.
2. Cementitious Binder Phase: The second phase is a hybrid binder combining Ordinary Portland Cement (OPC) with geopolymer-forming materials, such as granulated ground blast furnace slag (GGBS), fly ash, or metakaolin. The OPC contributes to early strength development through rapid hydration and the formation of calcium silicate hydrate (C—S—H) bonds, while the geopolymer-forming materials enable rapid hardening and long-term strength. In the binder, OPC constitutes at least 75% by weight, with the remaining portion being geopolymer materials. This hybrid approach facilitates enhanced mechanical performance and chemical resistance.

The resulting porous drainage material achieves:
1. Porosity: Ranging from 10-25% by volume, providing high water infiltration capacity. The interconnected pores form numerous minute channels that permit water passage while obstructing debris and insects. As a result, the surface drainage channels beneath the porous material covers do not provide breeding grounds for disease-carrying mosquitoes, safeguarding the community and promoting public health.
2. Filtration Rate: A minimum water filtration rate of 18,000 mm/hr, ensuring efficient surface-water management.
3. Strength: A 28-day compressive strength of at least 10 MPa, sufficient for pedestrian and light vehicular loads.
4. Density: Less than 1,850 kg/m³, offering a balance of lightweight properties and durability.

To optimize workability and performance, the cementitious binder may include superplasticizers. Examples include polycarboxylate amine (PCA), polycarboxylate ether (PCE), modified lignosulfonates, vinyl copolymers, or acrylic-based superplasticizers. These additives reduce water demand and improve workability of the material so that it can be formed into shapes including drain covers. For example, the workability imparted by the superplasticizer may optimize the mechanical performance of the porous drainage material post-processing, including skid resistance and loading capacity, while maintaining its remarkable water infiltration rate. The addition of superplasticizers also helps disperse the cementitious materials more uniformly in the mixture, enhancing the overall quality and strength of the matrix and ensuring the necessary interconnected porous channels for water drainage.

Optional pigments, constituting less than 10% of the binder, allow aesthetic customization for urban environments. These include matching a walkway or roadway color, or matching background greenery. The high customizability of the porous drainage materials, both in terms of functionality and aesthetics, results in a wide range of applications ranging from pavement and drainage to sports facilities, cycling tracks, estate areas and schools playgrounds.

While the porous solid material is self-supporting, it may optionally be incorporated into supporting frames to form drain cover units. The frame ensures structural stability and ease of installation, particularly in high-traffic or load-bearing scenarios.

The novel hybrid binder of the present achieves a synergistic interaction between Ordinary Portland Cement (OPC) hydration and geopolymerization in order to create strong bonds to the particulate fillers. During hydration of OPC, the constituents of ordinary Portland cement reacts with water to form C—S—H gel and calcium hydroxide, which provide initial binding strength.

Geopolymerization of GGBS/Fly Ash/Metakaolin: In the presence of calcium hydroxide from OPC, geopolymerization is activated, forming calcium-alumino-silicate hydrate (C-A-S-H). This secondary binding phase enhances long-term durability and resistance to chemical attack.

Adhesion to Recycled Aggregates: The calcium-based products of OPC hydration improve adhesion to irregular surfaces of recycled particulates, creating a cohesive matrix.

### Manufacturing Process

The production method ensures uniformity and optimal performance with a combination of dry mixing and wet mixing. In dry mixing, the OPC, geopolymer materials, and recycled particulates are mixed for 3-7 minutes to achieve a homogenous initial mixture. In wet mixing, water and superplasticizer are added, and the mixture is processed for 8-12 minutes to ensure uniform distribution.

Frame Loading and Compaction: The mixture is poured into a frame, such as a plastic or metal frame, placed on a vibration table, and compacted for a period of seconds to enhance the bonding between the particulates of phase 1.

Finishing: The surface is leveled to create modular units, such as drain covers.

### B. Detailed Porous Solid Material Compositions

### 1. Recycled Waste Materials

The recycled waste materials for the first phase of the composite porous materials are used primarily as aggregates are in concrete compositions, that is, they are more used for mechanical properties rather than based on particular chemical compositions. As such, the particular chemical components of the recycled waste materials is not critical. The waste materials, for example, tire crumbs, glass particulates, or recycled concrete aggregates, are sorted based primarily on particle size. Typical particle sizes range from 1 mm to 7 mm, more particularly, 2 mm to 5 mm. Smaller particle sizes provide a larger total surface area for binder adhesion and can increase binding strength, creating a stronger final product. Details of the particulates used in each composition are set forth in the Examples below.

### 2. Hybrid Binder

The hybrid binder includes a first component of Ordinary Portland Cement (OPC). Portland cement is a type of hydraulic cement that typically includes calcium oxides, silica, and alumina in various proportions. Compositions of Portland cement may include CaO in a range of 61-67%, SiO₂ in a range of 19-23%, Al₂O₃ in a range of 2.5-6%, Fe₂O₃ in a range of 0-6% and sulfate in a range of 1.5-4.5%. Various compositions of Portland cement are set forth in ASTM C150/C150M-16e1 “Standard Specification for Portland Cement”, available from ASTM International, West Conshohocken, PA, 2016, the disclosure of which is incorporated by reference herein. Any of these compositions may be used in the OPC binder portion of the present invention.

A geopolymer is an inorganic, aluminosilicate-based material formed through the reaction of aluminosilicate precursors with an alkali activator under controlled conditions. Geopolymers are synthesized through a process called geopolymerization, in which silicate and aluminate monomers polymerize to form a three-dimensional network of alumino-silicate or calcium-alumino-silicate bonds. The starting materials for geopolymer fabrication are primarily industrial by-products or natural minerals that contain reactive silica (SiO₂) and alumina (Al₂O₃). Common starting materials include granulated ground blast furnace slag (GGBS), fly ash, metakaolin, silica fume, natural pozzolans, and rice husk ash.

Slag is the material left over when a metal has been separated (e.g., smelted) from its respective metal ore. Granulated ground blast furnace slag is produced by quenching of molten iron slag (a by-product of iron and steel-making) from a blast furnace followed by grinding. The main components of granulated ground blast furnace slag are CaO (30-50%), SiO₂ (28-38%), Al₂O₃ (8-24%), and MgO (1-18%). All percentages set forth in the description are weight percentages unless otherwise indicated. A particular example composition of granulated ground blast furnace slag was used in the working examples and is set forth below.

Fly ash is a fine, powdery residue produced from coal combustion in power plants. Class F fly ash is rich in silica and alumina, while Class C also contains significant calcium content.

Metakaolin is a thermally activated clay (calcined kaolin) that is highly reactive due to its amorphous aluminosilicate structure.

Silica fume is a by-product of silicon or ferrosilicon alloy production, and is typically an ultrafine powder with high silica content. Silica fume may be added in amounts of 1-5% by weight, contributing to increased density and durability. The addition of silica fume facilitates pozzolanic reactions between silica fume and calcium hydroxide (produced during cement hydration), generating additional calcium silicate hydrate (C—S—H). Silica fume also increases the degree of hydration of the cementitious binder. Not only does this increase the strength of the concrete mixture, but it also improves its durability by reducing bleeding. The extent of these changes depends on the dosage of silica fume and the overall mix design.

Although geopolymerization is typically initiated by alkali activators such as sodium silicate, sodium hydroxide, or potassium hydroxide, in the hybrid binders of the present invention, the calcium hydroxide (Ca(OH)₂) generated during OPC hydration can activate the geopolymerization process, eliminating the need for additional alkali activators.

The use of geopolymer materials optimizes packing density, filling up the voids and enhancing the adhesion between the recycled tire rubber crumbs, aggregates, or other recycled waste materials. Shrinkage compensator may also be added counteract drying shrinkage during the curing process of geopolymerization, hence mitigating the potential of the porous material to crack.

### C. Porous Material Properties

Through the use of the hybrid OPC/gcopolymer binder composition, the recycled particulate first phase, coupled with the rapid hardening geopolymerization technology and cement hydration, the overall material displays high performance in multiple parameters.

The density of the porous drainage material remains below 1,850 kg/m³. This level of density indicates a sufficiently high packing compactness of the particles in the material, while still allowing a high infiltration rate of water through the material.

Tests using simulated rainwater (e.g., with debris typical of storm runoff) passing through the porous drainage materials of the present invention show the water output contains less than 1% by weight of solids. This means that the porous drainage material, while having a high water infiltration rate, has an average low pore size such that not only larger debris, but sediments and small objects are blocked from entering storm drains positioned beneath the material. This effectively prevents any clogging or blockage of the storm drains, since continuous water flow is crucial, especially during heavy rainstorms.

Importantly, the porous material demonstrates a high skid resistance. Skid resistance is required for both roadway applications and pedestrian walkway applications. This is a measurement of how slippery a surface is-regardless of whether it is a floor or a pavement. The pendulum test value (PTV) also calculates slip-resistance. PTV is measured with a piece of equipment called a pendulum, and this equipment is used to simulate either a shoe or a bare foot on a surface. Measured skid resistance for materials from the Examples below is at least 60. Skid resistance (PTV) is measured on a 100 point scale, with higher values indicating a higher level of skid resistance.

In embodiments of the present invention, the porous drainage materials are formed within supporting frames to create variable shapes such as drain covers, gutters for walkways, running tracks, or parking areas. The supporting frames may be made from metal or high-strength polymers. By forming the porous drainage materials within a frame, discrete structures are cast which can be delivered to a worksite for installation in much the same manner as conventional concrete pavers or blocks. The frames also impart additional strength to the porous drainage materials. The frames include side regions and porous bottoms. Mechanical features such as keyholes can be formed for ease of handling by drainage material installers. Using mechanical supporting frames, the drain covers have a FACTA specified loading capacity of Class A or higher.

Specific compositions and their properties are set forth in the Examples below:

### EXAMPLES

### Example 1—Composition of Starting Materials for the Porous Drainage Material

The OPC used in the Examples is CEM I 52.5 ordinary Portland cement (OPC).

The Ground granulated blast-furnace slag (GGBS) used is grade S95 with a minimum surface area of 400 m²/kg, is used.

Silica fume with a specific surface area larger than 15,000 m²/kg and an accelerated pozzolanic activity index above 105% at 7 days is also incorporated to enhance durability and performance.

The OPC, GGBS and Silica Fume compositions are set forth in Table 1:

TABLE 1
Chemical Composition of Starting Materials

| Material | SiO₂ | Al₂O₃ | CaO | MgO | SO₃ | Fe₂O₃ | K₂O | TiO₂ | LOI |
|---|---|---|---|---|---|---|---|---|---|
| OPC | 22.1 | 5.73 | 62.5 | 1.71 | 4.02 | 2.23 | 0.76 | — | 0.95 |
| GGBS | 30.5 | 13.4 | 42.3 | 8.36 | 3.09 | 0.26 | 0.44 | 1.33 | 0.32 |
| Silica | 55.9 | 34.6 | 1.2 | 0.69 | 0.51 | 3.46 | 1.73 | 1.47 | 0.44 |
| fume | | | | | | | | | |

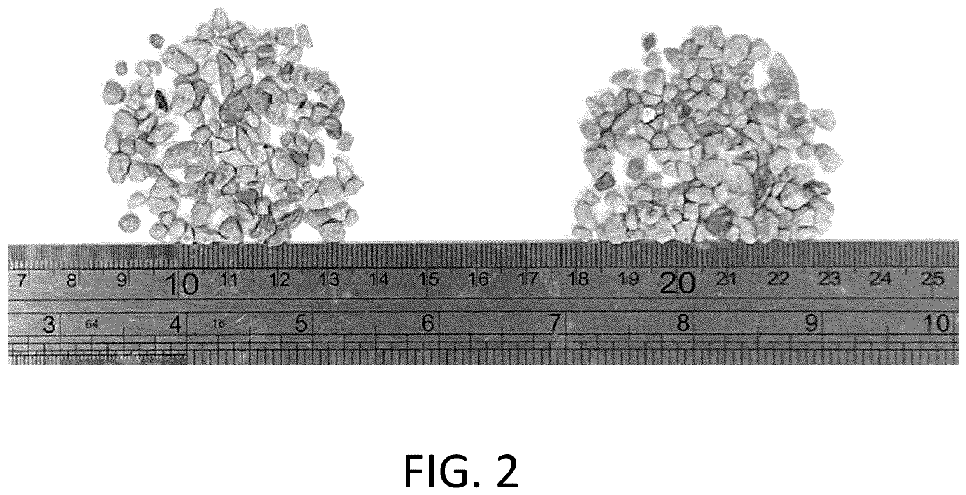

Recycled aggregates are selected for the porous drainage material as the merit of low carbon emission. The size of the recycled aggregate ranges between 2.36 mm and 5 mm as shown in FIG. 2.

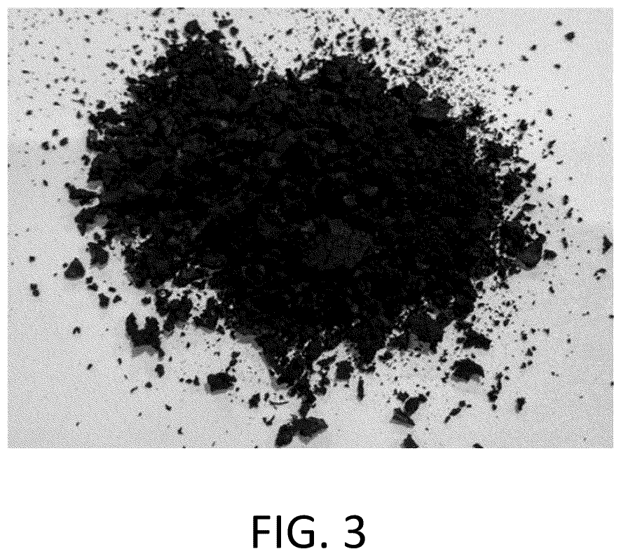

Recycled rubber tire crumb with size between 2.36 mm and 5 mm was adopted shown in FIG. 3. The tire crumb rubber is visually inspected to be free from impurities to ensure its suitability for use.

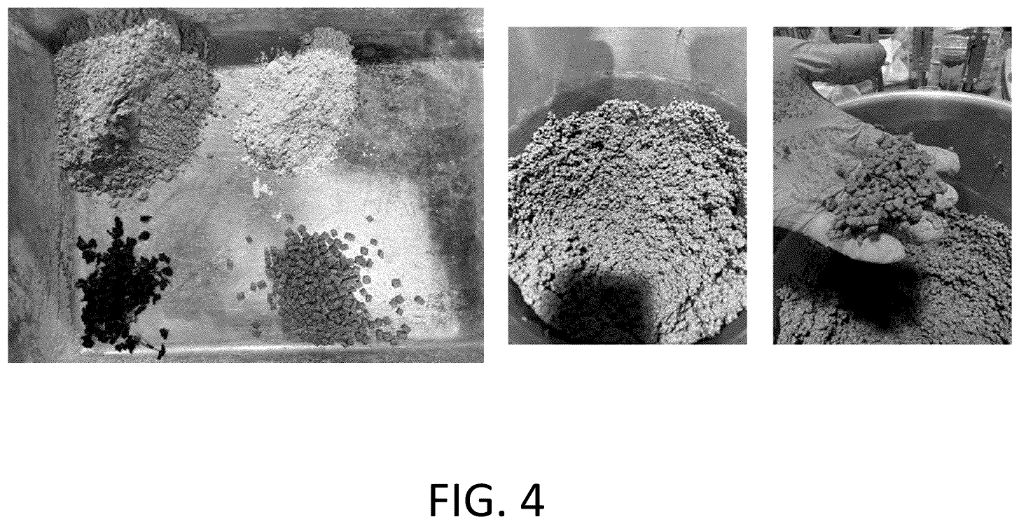

Recycled plastic with size between 2.36 mm and 5 mm was adopted as shown in FIG. 4. Similar to the tire crumb rubber, recycled plastic is visually inspected to ensure it is free from impurities before use.

### Example 2—Development of Mix Proportion and Testing Results

### A. Mix Formulation:

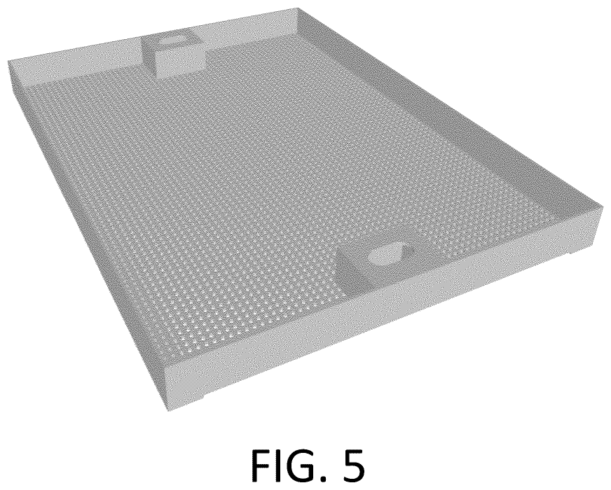

A total of 12 formulations of the porous drainage materials were selected as set forth in Table 2. The formulations were cast within cubic molds for compressive strength test, and the metal holding frames shown in FIG. 5 for mechanical and performance testing including infiltration rate, skid resistance value, total debris content and loading capacity. Particularly, the infiltration rate testing is carried out in accordance with the standards under ASTM C1701/C1701M-09.

TABLE 2
Selected Formulations of Porous Solid Surface-Drainage Materials

| | Composition (kg/m\hat{ }3) | | | | | | | | |
|---|---|---|---|---|---|---|---|---|---|
| | | | | | Recycled | | | | |
| | | | | Recycled | rubber | | | Water | |
| Formulation | | | Silica | concrete | tyre | Recycled | | reducing | Concrete |
| No. | OPC | GGBS | fume | aggregate | crumb | plastic | Water | agent | pigment |
| 1 | 359 | — | — | 1248 | 5.0 | 3.8 | 133 | 1.8 | — |
| 2 | 352 | — | — | 1257 | 5.1 | 3.8 | 130 | 1.8 | — |
| 3 | 345 | — | — | 1267 | 5.1 | 3.8 | 128 | 1.7 | — |
| 4 | 338 | — | — | 1276 | 5.1 | 3.9 | 125 | 1.7 | — |
| 5 | 310 | 34.5 | — | 1267 | 5.1 | 3.8 | 128 | 1.7 | — |
| 6 | 276 | 69.0 | — | 1267 | 5.1 | 3.8 | 128 | 1.7 | — |
| 7 | 241 | 103.4 | — | 1267 | 5.1 | 3.8 | 128 | 1.7 | — |
| 8 | 305 | 34.5 | 5.2 | 1267 | 5.1 | 3.8 | 128 | 1.7 | — |
| 9 | 302 | 34.5 | 8.6 | 1267 | 5.1 | 3.8 | 128 | 1.7 | — |
| 10 | 298 | 34.5 | 12.1 | 1267 | 5.1 | 3.8 | 128 | 1.7 | — |
| 11 | 300 | 34.3 | 8.6 | 1259 | 5.1 | 3.8 | 127 | 1.7 | 10.3 |
| 12 | 298 | 34.1 | 8.5 | 1252 | 5.0 | 3.8 | 126 | 1.7 | 20.4 |

TABLE 3
Typical Performance of the Selected Formulations

| Formulation | Infiltration | 28-day compressive |
|---|---|---|
| No. | rate (mm/hr) | strength (MPa) |
| 1 | 23,900 | 8.2 |
| 2 | 23,500 | 9.2 |
| 3 | 22,900 | 9.8 |
| 4 | 21,500 | 10.3 |
| 5 | 22,500 | 10.9 |
| 6 | 21,900 | 11.3 |
| 7 | 21,000 | 11.4 |
| 8 | 22,200 | 11.9 |
| 9 | 21,900 | 12.1 |
| 10 | 21,300 | 12.2 |
| 11 | 21,800 | 11.6 |
| 12 | 21,700 | 11.5 |

### Fabrication of Samples for Mechanical Testing:

The hybrid binder materials of the binder phase 2 and the recycled materials of the particulate phase 1 are mixed in a concrete mixer for 3-7 minutes to obtain a first mixture.

Water and superplasticizer are then added to the first mixture and mixed for 8-12 minutes to obtain a second mixture.

The second mixture is transferred into the holding frame while ensuring even distribution of the second mixture within the holding frame.

The holding frame loaded with the second mixture is placed on a vibration table, and vibration is applied for 8-15 seconds for compaction.

Once the vibration compaction is complete, the surface is flattened and the mixture is allowed to set. The solidified modular unit obtained can be used as porous drain cover.

### Refinement of the Composition

Formulations 1-4 are comparative examples with a binder phase formed from only OPC. These are base compositions used to determine the best base proportions for further refinements and to demonstrate the technical effect of the hybrid OPC-geopolymer binder on the porous drainage material as compared to prior art OPC binders.

Formulations 5-12 incorporation geopolymer ingredients of Ground Granulated Blast-Furnace Slag (GGBS) or GGBS plus silica fume.

As seen in Formulations 3, 5, 6 and 7, adjusting the ratio of Ordinary Portland Cement (OPC) and GGBS, as the GGBS replacement content increases from 0 kg/m³ to 103.4 kg/m³ (as shown in Table 2), the compressive strength of the porous solid surface-water drainage material increases to up to 11.4 MPa (as shown in Table 3). While there is a slight decrease in infiltration rates coupled with the increase in GGBS content, such a decrease is attributed to the enhancement of the workability and flowability of the fresh resultant mixture, while the effect of the presence of GGBS on the infiltration rate of the porous solid surface-water drainage material is relatively insignificant.

Formulation 5, of the four formulations, was chosen for further adjustments and tests, due to its improved compressive strength of 10.9 MPa while maintaining a reasonably high infiltration rate of 22,500 mm/hr.

The incorporation of silica fume further increases the degree of hydration of the cementitious binding matrix, which in turn improves the strength and durability of the porous solid surface-water drainage material through reduced bleeding. This can be observed in Formulations 5, 8, 9 and 10, wherein the partially increasing substitution of silica fume contents from 0 kg/m³ to 12.1 kg/m³ increases the compressive strength of the material from 10.9 MPa to 12.2 MPa.

However, the extent of the changes brought forth by the incorporation of silica fume also depends on the dosage of the silica fume and overall mix design. For example, in Formulation 10, while the compressive strength of the porous material reaches a high level of 12.2 MPa, its infiltration rate drops to 21,300 mm/hr.

Therefore, balancing the compressive strength and the infiltration rate, Formulation 9 is chosen as the optimal mix among the three.

To widen the potential applications of the porous drainage materials in more facilities and scenarios, it is favorable to include coloration to the cement for aesthetic purposes.

Pigments in general are chemically inert. Therefore, the chemical reactions within the cement matrices should not be interfered or impacted even with the incorporation of pigments. However, excessive use may impact the workability and compaction of the porous material.

As observed in Formulations 9, 11 and 12, incorporation of 10.3 kg/m³ pigment in the cementitious binder based on Formula 9 causes minimal impact in infiltration rate (from 21,900 mm/hr to 21,800 mm/hr); and a reasonably high compressive strength is retained (11.6 MPa). However, if an increased amount of pigment (20.4 kg/m³) is incorporated, the infiltration rate and compressive strength is further reduced, showing the potential detrimental effects of high pigment contents on the performances of the porous drainage materials.

The skid resistance and loading capacity of the porous drainage material with waste material usage rate of more than 70% of the total weight of the material are tested according to BS EN 13036-4 and FACTA specification for fabricated access covers, respectively. The pendulum test values, PTV (equivalent to skid resistance values, SRV), of the specimen is greater than or equal to 60. With a 30 mm thickness holding frame, the loading capacity is Class A, while with a 60 mm thickness holding frame, the loading capacity is Class C.

### Example 3—Design of Holding Frame

The porous drainage material is supported by a holding frame made of metal, preferably stainless steel or other strong alloys, metals or polymers. A general design of the holding frame is shown in FIG. 5.

In particular, a specific embodiment of the holding frame and upgraded portions are made of the same Grade 304 stainless steel material with 2 mm thickness as the original frame. Two keyhole boxes measuring 50 mm by 40 mm by 26 mm were added in the center of the short 300 mm sides of the standard 300 mm×400 mm×30 mm holding frame. The 50 mm edge of the boxes are parallel to the short sides of the frame. The keyhole boxes enabling convenient handles allow workers to install and remove the porous drainage material more easily, making it easier to handle, install and maintain for customers.

It is noted that the holding frame of FIG. 5 may be customized for drain cover applications. When used as a drain cover, a heavy gauge aluminum or stainless steel sheet material may form a particular drain cover configuration based on the type of drain cover and its location—for example, roadway drain covers necessitate the use of stronger frame materials while sidewalk pavements do not as strong of a frame material. In some cases, additional metal connector portions may be formed on the frame to affix to existing drain openings as by welding or through the use of mechanical fasteners.

While the standard 300 mm×400 mm×30 mm holding frame is used for Class A pedestrian-level loading capacity; alternatively, the standard 300 mm×400 mm×60 mm holding frame for Class C vehicle-level loading capacity may also be used made of the same Grade 304 stainless steel material with 5 mm thickness, depending on the desired application. Because drainage covers, in particular, present many design challenges in terms of shapes and positions, the flexibility provided by the frame design permits ready formation of any needed drain cover design.

### Example 4—Industrial Applicability

As demonstrated in the various tests above, the porous drainage material of the present invention incorporates a high level of recycled materials while displaying extremely high infiltration rates, easily capable of catering to scenarios equivalent to Black Rainstorm Signal level of heavy rain in Hong Kong context and ensuring a high safety of use as reflected in its high skid resistance and core strength.

The porous drainage material can also be, through the use of different designs and dimensions of metal holding frames, shaped differently and tunable in terms of loading capacity to be installed and utilized in different applications, in particular, for use as solid drain covers to replace conventional grating drain covers.

The fabrication method, as shown in Example 2, is relatively straightforward while being applicable for upscale manufacture; and with the proper choices or tailoring of holding frame designs, the porous drainage material can be mass produced and easily installed in different applications.

Coupled with aesthetic properties through pigment coloration which is tested to not significantly impact the performance of the porous solid surface-water drainage material, the material has great design flexibility and customizability in both utility and aesthetics, having a wide range of applications, from infrastructures including pavement and drainage covers, to different facilities including cycling tracks, various sports facilities, schools and residential areas. It is therefore anticipated that the porous drainage material can be applied in large scales across a wide variety of scenarios.

Several embodiments of the present disclosure and features of details are briefly described above. The embodiments described in the present disclosure may be easily used as a basis for designing or modifying other processes and structures for realizing the same or similar objectives and/or obtaining the same or similar advantages introduced in the embodiments of the present disclosure. Such equivalent construction does not depart from the spirit and scope of the present disclosure, and various variations, replacements, and modifications can be made without departing from the spirit and scope of the present disclosure.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within μm, within 1 μm, or within 0.5 μm located along the same plane. When reference is made to “substantially” the same numerical value or characteristic, the term may refer to a value within ±10%, ±5%, ±1%, or ±0.5% of the average of the values.

1. A porous solid surface-water drainage material comprising:
a first phase comprising a recycled particulate mixture bound with a second phase of cementitious binder, the first phase selected from the group consisting of recycled waste concrete aggregates, recycled waste glass, recycled waste plastic, recycled tire rubber crumbs, and mixtures thereof;
the second phase of cementitious binder comprising a hybrid OPC-geopolymer binder phase of Ordinary Portland Cement (OPC) and a geopolymer-forming material selected from granulated ground blast furnace slag (GGBS), fly ash, metakaolin, or mixtures thereof, the OPC portion creating calcium silicate hydrate bonds for binding to the first phase recycled particulate mixture to strengthen the porous solid surface-water drainage material, and the geopolymer forming a secondary rapid-hardening portion of the second phase of cementitious binder, reacting in part with calcium hydroxide produced from OPC hydration to create calcium-alumino-silicate hydrate, wherein the ratio of OPC to geopolymer in the second phase of cementitious binder being 3 to 1 or higher;
wherein the first phase ranges from approximately 70 to approximately 80 weight percent of the material and the second phase ranges from approximately 15 to approximately 25 weight percent of the material;
the porous solid surface-water drainage material having a porosity of 10-25 volume percent, a water filtration rate of at least 18,000 mm/hr, a 28-day compressive strength of at least 10 MPa, and a density of less than 1,850 kg/m³.

2. The porous solid surface-water drainage material of claim 1, wherein the second phase further comprises silica fume in an amount of approximately 1 to 5 weight percent of the second phase.

3. The porous solid surface-water drainage material of claim 1, further comprising superplasticizer selected from polycarboxylate amine (PCA), polycarboxylate ether (PCE), modified lignosulfonates, vinyl copolymers, acrylic-based superplasticizers, or a combination thereof.

4. The porous solid surface-water drainage material of claim 1, further comprising concrete pigments with an amount of less than 10% by weight relative to the second phase of the material.

5. The porous solid surface-water drainage material of claim 1, further comprising a metal supporting frame surrounding a block of the porous solid surface-water drainage material.

6. The porous solid surface-water drainage material of claim 1, wherein a solids content of debris-containing water passing through the porous solid surface-water drainage material is less than 1% by weight of a total debris content in the debris-containing water.

7. The porous solid surface-water drainage material of claim 1, wherein a skid resistance value (SRV) is at least 60.

8. A drain cover including the porous solid surface-water drainage material and frame of claim 5.

9. A method of producing the porous solid surface-water drainage material of claim 1, comprising:
dry-mixing the OPC, geopolymer, and recycled particulate mixture to obtain a first dry mixture;
adding water and superplasticizer to the first dry mixture and mixing to a second wet mixture;
transferring the second wet mixture into a holding frame while ensuring even distribution of the second wet mixture within the holding frame;
compacting and flattening the second wet mixture within the holding frame.

10. The method of claim 9, wherein the holding frame is a metal holding frame.

11. The method of claim 10, wherein the metal holding frame is a storm drain cover holding frame.

12. The method of claim 9, further comprising adding a dry pigment to the dry mixture.
